(19) United States
(12) Patent Application Publication
(10) Pub. No.: US 2003/0171948 A1
(43) Pub. Date: Sep. 11, 2003

(54) Global consolidated clearance methods and systems

(75) Inventors: Mikie Thomas, Dallas, GA (US); Anthony Creasy, Suwanee, GA (US); Robert Papetti, Marietta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/366,111

(22) Filed: Feb. 12, 2003

Related U.S. Application Data
(60) Provisional application No. 60/356,692, filed on Feb. 13, 2002.

(51) Int. Cl. G06F 17/60

(52) U.S. Cl. 705/1

(57) ABSTRACT

The present invention discloses systems and methods for automated consolidation of packages bound for international destinations. A first embodiment is disclosed for a client-side shipping application that automates the consolidation of packages and shipping of packages. In a second disclosed embodiment, the aggregation of like shipments occurs in one or more backend applications preferably residing on a service provider server. This will eliminate the need to produce and apply an over label for each package in the consolidated shipment. The first embodiment will address the elimination of the manual process of producing the address, over label and master invoice.

### CROSS REFERENCE TO RELATED APPLICATIONS

The present application claims priority from U.S. Provisional Patent Application Serial No. 60/356,692 entitled “Global Consolidated Clearance Methods and Systems”, filed on Feb. 13, 2002, the contents of which are herein incorporated by reference.

### FIELD OF THE INVENTION

Global package shipping methods and systems that automate and enhance the consolidated clearance shipment process used in international shipping.

### BACKGROUND OF THE INVENTION

Fees and tariffs are charged for every internationally shipped package as the package passes through the port of entry of the destination country (hereafter “port of import” or “port of entry”). A process known as consolidated clearance is known in the art that allows a shipper to group multiple shipments that clear customs through the same port of import. In this process, a group of shipments with different destination addresses are treated as a single shipment at the port of import and, as a result, the brokerage import fees and shipping costs for the group of shipments are significantly less than if the shipments were shipped separately. A number of limitations exist on the consolidated clearance process used today. For example, a shipper can only consolidate shipments that have the same port of import, same ship date, same service level, same importer of record and same destination country. Moreover, the process for preparing shipments for consolidated clearance is highly manual and therefore is both time-consuming and prone to human error.

FIG. 1 illustrates the steps typically required to prepare a consolidated clearance shipment. In Step 100, the shipper identifies those packages that share the same port of import, ship date, service level, importer of record and destination country. Thus, in the consolidated clearance process known in the art the shipper must manually identify those packages that share common shipping characteristics that will permit them to be consolidated. If a shipper accidentally misses a package that could have been included in a consolidated clearance shipment, the process of preparing shipping labels must start afresh and the over-labels, which identifies the number of packages in the consolidated shipment, must be changed for each package in a consolidated shipment.

In Step 110, the shipper manually completes a paper waybill for the document box of the consolidated clearance group. The document box (or “dummy shipment”) is a box supplied by a commercial carrier (sometimes referred to herein as a “service provider”) that identifies the shipment as a consolidated clearance shipment and holds all the necessary customs paperwork for the shipment. The document box is the lead package of a consolidated clearance group; the other packages in the group are referred to as child packages. Waybills are well known in international shipping and the waybill used in a consolidated clearance shipment is exactly like any other international shipment. The shipper completes a waybill for each consolidated clearance shipment.

In Step 120, the shipper completes shipping labels for each of the child packages in the consolidated clearance shipment. There may be as many as three labels required for each child package in the group, including an address label identifying the final destination address of the package, a World Wide Services Tracking Label (WWSTL) that includes a shipment identification number that is used for tracking the individual package, and an over-label that is placed over the final destination address label that that identifies the port of import and package count of the complete consolidated clearance shipment. The customer will also include on the WWSTL information such as package weight, child shipment package count (x of y), UPS account number and service level. In the past, the shipper had to manually complete or generate each of the three shipping labels required for the consolidated clearance shipment. In recent years, however, package shipping applications known in the art allow the generation of a final destination address label that includes the information from the WWSTL. These shipping applications thus eliminated the need for a WWSTL. Using these applications, the service providers require only the final destination address label and over-label for the consolidated clearance process.

In Step 130, the user completes a master invoice for the entire consolidated shipment and packing slips for each child shipment within the consolidated shipment. The master invoice (usually multiple copies of the master invoice), packing slips and any other documents required for international shipping are placed in the document box.

In Step 140, an employee of the service provider picks up the consolidated clearance shipment, segregates the shipment and places them in the package car. Because over-labels are affixed to the various packages in the consolidated shipment, the packages are handled as a single shipment when transported to a sorting facility.

In Step 150, the Operations Data Capture (ODC) or export site enters the shipment data for the consolidated shipment into the service provider's operation system. This usually entails a service provider employee physically retrieving the master invoice from the document box and manually inputting the shipment and invoice information into the service provider computer system. Depending on the sophistication of the shipper's package shipping system, the individual packages in the consolidated shipment may be bar code scanned to capture shipment information. Alternatively, the information may be electronically transmitted from the shipper to the service provider's operation system.

In Step 160, the consolidated shipment reaches the port of import where the packages in the consolidated shipment are handled as a single shipment. At this location, the over-label identifying the port of import is removed from each package, revealing the final destination address for the respective shipments. The individual shipments are then delivered to their respective final destination addresses.

As noted above, the existing processes for global consolidated clearance shipments are manual and prone to error. A need therefore exists in the industry for methods and systems to automate and enhance the consolidated clearance process used in international shipping. The present invention addresses limitations in the current consolidate clearance shipping systems, some of which have been identified above.

### SUMMARY OF THE INVENTION

The present invention discloses systems and methods for automated consolidation of packages bound for international destinations. A first embodiment is disclosed for a client-side shipping application that automates the consolidation of packages and shipping of packages. In a second disclosed embodiment, the aggregation of like shipments occurs in one or more backend applications preferably residing on a service provider server. This will eliminate the need to produce and apply an over label for each package in the consolidated shipment. The first embodiment will address the elimination of the manual process of producing the address, over label and master invoice.

In one embodiment of the present invention, a shipping system for shipping international packages is disclosed that includes a port of entry database; and a consolidated clearance application that is configured to perform the steps of: capturing shipment characteristics of a plurality of packages, the shipment characteristics including an international destination and a consignee associated with each of the packages; querying the port of entry database with at least one of the consignee and international destination to assign a consolidated port of entry to each package; assigning each package to a global consolidated shipment in accordance with a set of consolidation guidelines; and generating global consolidated shipping labels for each package.

Other disclosed embodiments of the present invention are disclosed that are similar to the first embodiment but also have the consolidated clearance application configured to generate a consignee address label and an over-label. In one of these embodiments, the consignee address label and over-label are printed on a single thermal stock.

In still another embodiment of the present invention a computer readable substrate having a set of instructions save thereupon is disclosed, wherein the set of instructions, when executed, perform the steps of: capturing a first set of shipment characteristics that are associated with a first package that is bound for a first destination; capturing a second set of shipment characteristics that are associated with a second package bound for a second destination; aggregating the first and second packages as a consolidated international shipment if the first and second sets of shipment characteristics satisfy a requirement for consolidated shipping; associating a consolidated port of entry to the consolidated international shipment; and generating a consignee address label and an over-label for the first and second packages.

In still another embodiment of the present invention a computer readable substrate having a set of instructions save thereupon is disclosed, wherein the set of instructions, when executed, perform the steps of: capturing a first set of shipment characteristics, including a first destination address and a first ship type, that are associated with a first package that is bound for a first destination; capturing a second set of shipment characteristics, including a second destination address and a second ship type, that are associated with a second package bound for a second destination; aggregating the first and second packages as a consolidated international shipment if the first and second sets of shipment characteristics satisfy a requirement for consolidated shipping; associating a consolidated port of entry to the consolidated international shipment; and generating a consignee address label and an over-label for the first and second packages.

In still another embodiment of the present invention a computer readable substrate having a set of instructions save thereupon is disclosed, wherein the set of instructions, when executed, perform the steps of: capturing a first set of shipment characteristics, including a first destination address and a first ship type, that are associated with a first package that is bound for a first destination; capturing a second set of shipment characteristics, including a second destination address and a second ship type, that are associated with a second package bound for a second destination; aggregating the first and second packages as a consolidated international shipment if the first and second sets of shipment characteristics satisfy a requirement for consolidated shipping, including whether the first and second shipment types identify the first and second packages as international shipments and said first and second packages have the same importer of record; associating a consolidated port of entry to the consolidated international shipment; and generating a consignee address label and an over-label for the first and second packages.

In still another embodiment of the present invention a computer readable substrate having a set of instructions save thereupon is disclosed, wherein the set of instructions, when executed, perform the steps of: capturing a first set of shipment characteristics, including a first destination address and a first ship type, that are associated with a first package that is bound for a first destination; capturing a second set of shipment characteristics, including a second destination address and a second ship type, that are associated with a second package bound for a second destination; aggregating the first and second packages as a consolidated international shipment if the first and second sets of shipment characteristics satisfy a requirement for consolidated shipping, including whether the first and second shipment types identify the first and second packages as international shipments and said first and second packages share a common importer of record and a common exporter; associating a consolidated port of entry to the consolidated international shipment; and generating a consignee address label and an over-label for the first and second packages.

In still another embodiment of the present invention a computer readable substrate having a set of instructions save thereupon is disclosed, wherein the set of instructions, when executed, perform the steps of: capturing a first set of shipment characteristics, including a first destination address and a first ship type, that are associated with a first package that is bound for a first destination; capturing a second set of shipment characteristics, including a second destination address and a second ship type, that are associated with a second package bound for a second destination; aggregating the first and second packages as a consolidated international shipment if the first and second sets of shipment characteristics satisfy a requirement for consolidated shipping, including whether the first and second shipment types identify the first and second packages as international shipments and said first and second packages In still another embodiment of the present invention a computer readable substrate having a set of instructions save thereupon is disclosed, wherein the set of instructions, when executed, perform the steps of: capturing a first set of shipment characteristics, including a first destination address and a first ship type, that are associated with a first package that is bound for a first destination; capturing a second set of shipment characteristics, including a second destination address and a second ship type, that are associated with a second package bound for a second destination; aggregating the first and second packages as a consolidated international shipment if the first and second sets of shipment characteristics satisfy a requirement for consolidated shipping, including whether the first and second shipment types identify the first and second packages as international shipments and said first and second packages share a common importer of record, exporter and service level; associating a consolidated port of entry to the consolidated international shipment; and generating a consignee address label and an over-label for the first and second packages.

In still another embodiment of the present invention a computer readable substrate having a set of instructions save thereupon is disclosed, wherein the set of instructions, when executed, perform the steps of: capturing a first set of shipment characteristics that are associated with a first package that is bound for a first destination; capturing a second set of shipment characteristics that are associated with a second package bound for a second destination; aggregating the first and second packages as a consolidated international shipment if the first and second sets of shipment characteristics satisfy a requirement for consolidated shipping; associating a consolidated port of entry to the consolidated international shipment by querying a port of entry table with at least one of a shipment type, shipment date, import date, service level, destination country and importer of record; and generating a consignee address label and an over-label for the first and second packages.

In still another embodiment of the present invention a computer readable substrate having a set of instructions save thereupon is disclosed, wherein the set of instructions, when executed, perform the steps of: capturing a first set of shipment characteristics that are associated with a first package that is bound for a first destination; capturing a second set of shipment characteristics that are associated with a second package bound for a second destination; aggregating the first and second packages as a consolidated international shipment if the first and second sets of shipment characteristics satisfy a requirement for consolidated shipping; associating a consolidated port of entry to the consolidated international shipment; and generating a consignee address label and an over-label for the first and second packages; wherein said consolidation process occurs as part of a closeout or end of day process.

In still another embodiment of the present invention a computer readable substrate having a set of instructions save thereupon is disclosed, wherein the set of instructions, when executed, perform the steps of: capturing a first set of shipment characteristics that are associated with a first package that is bound for a first destination; capturing a second set of shipment characteristics that are associated with a second package bound for a second destination; aggregating the first and second packages as a consolidated international shipment if the first and second sets of shipment characteristics satisfy a requirement for consolidated shipping; associating a consolidated port of entry to the consolidated international shipment; and generating a consignee address label and an over-label for the first and second packages; and wherein the first and second packages are bound for different consignees located in different countries within the European Union.

In still other embodiments of the present invention, the consolidation of packages occurs as part of a backend processing based on consolidation guidelines set forth by either the shipper, the carrier or a combination of both.

### BRIEF DESCRIPTION OF THE FIGURES

FIG. 1 is a process flow of the steps typically required to prepare a consolidated clearance shipment using systems and processes known in the art.

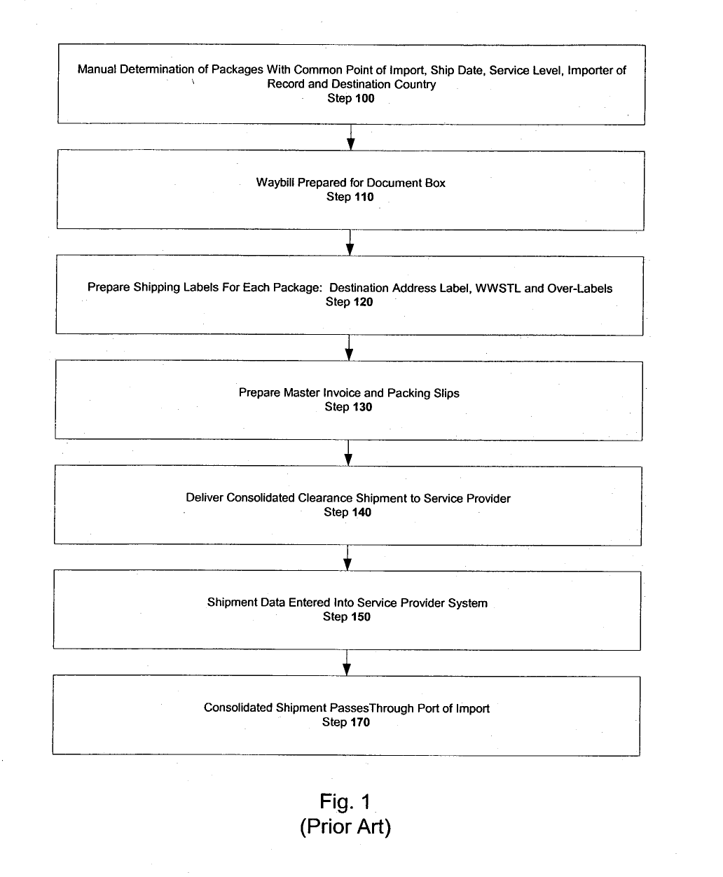

FIG. 2 is an operational process flow diagram of a global consolidated clearance system in accordance with an embodiment of the present invention.

FIG. 3 illustrates a process flow of a global consolidated clearance shipment in a global consolidated clearance system.

FIG. 4 illustrates a typical global consolidated clearance label and over-label combination.

FIG. 5 illustrates the operation of a global consolidated clearance application as it processes a consolidated clearance doc box shipment as part of a closeout or end-of-day process.

FIG. 6 illustrates a process flow for a second embodiment of a global consolidated clearance system in accordance with the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

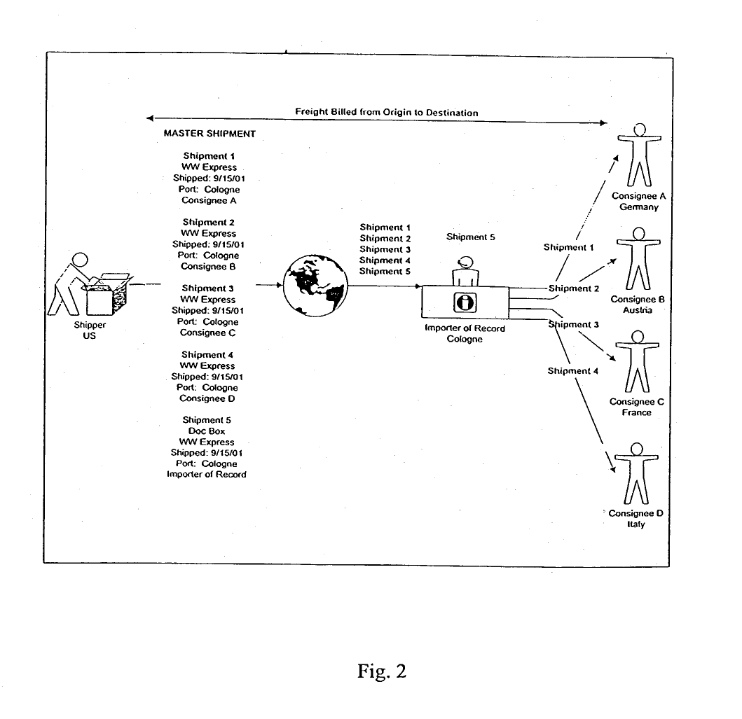

FIG. 2 is an operational process flow overview of a global consolidated clearance system (GCCS) 10 in accordance with one embodiment of the present invention. The GCCS 10 provides an automated solution for consolidated clearance shipping that includes a client shipping system, automated upload of Package Level Detail (PLD) information, printing of both address label and over-label on a single thermal label, planned flow to the consignee and simplified billing. In a preferred embodiment, the GCCS 10 provides for the consolidation of shipments that are bound to multiple European Union (EU) countries into a single outbound EU shipment. The EU shipment passes through a single EU port of entry, clears customs, has the over-labels removed by operations, splits and continues on to final delivery.

In the illustration of FIG. 2, shipments bound to Germany, Austria, France and Italy are electronically linked to a global consolidated clearance doc box (GCC Doc Box) 15 shipment and are cleared as a single shipment in a single port of entry (Cologne). A system-generated eleven-digit shipment ID number of the document box becomes the master shipment identifier for the consolidated clearance shipment. In this embodiment, shipments that are eligible for consolidated clearance require only that individual packages have the same ship date, importer of record, service level and billing option. Unlike consolidated clearance systems known in the art, the shipments in the GCCS 10 of the present invention are not required to share the same destination country. Instead, and as shown in this example, the packages may be bound for consignees that are located in different countries within the EU.

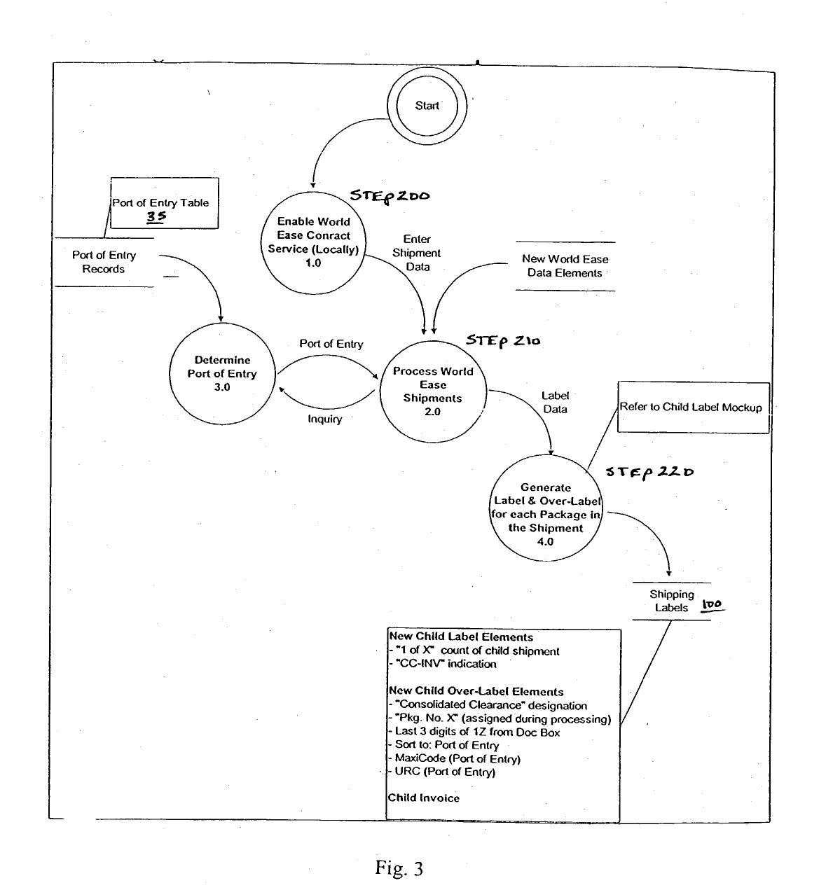

FIG. 3 illustrates the process flow of a global consolidated clearance child shipment (GCC child shipment) 20 in a GCCS 10 in accordance with an embodiment of the present invention. In Step 200, a global consolidated clearance service provider (GCC service provider) 25 authorizes one or more shippers to use the GCCS 10 system. The inclusion of an authorization step gives the service provider increased control over the consolidated shipment process; however, one of ordinary skill in the art will recognize that a separate authorization step is not essential to implementing the consolidation processes described below.

In a preferred embodiment, once a shipper is authorized to access and use the GCCS 10, the GCC service provider 25 installs a global consolidated clearance shipping application (GCC shipping application) 30 as a component of the shipper's in-house or local computer system. One of ordinary skill will readily recognize that the present invention would be equally advantageous if some or all of the GCC shipping application 30 resided on the GCC service provider's server and was accessed by shippers via the Internet or other electronic communication methods known in the art.

In a preferred embodiment, part of the installation procedure for a shipper includes creating one or more tables and/or databases for available ports of entry (hereafter cumulatively referred to as “port of entry tables” 35). The ports of entry available to a shipper in the consolidation clearance process can vary between shippers and between shipment types. For example, different port of entry tables 35 may be used for regular (non-consolidated) international shipments, consolidated clearance shipments, and EU consolidated clearance shipments. Alternatively, a single port of entry table 35 may be used that contains different port of entry detail for each of the aforementioned shipment types.

In Step 210, the shipper selects a consignee and enters the shipment characteristics for a package via the GCC shipping application 30. A shipment characteristic that the shipper will provide is the international shipment type for the package. In an embodiment, international shipments options include a regular or non-consolidated international shipment, a EU consolidated clearance shipment (when the package is to be consolidated and is destined for a EU country) and a consolidated clearance shipment (when the package is to be consolidated and is destined for a country that is not part of the EU). If a consolidated clearance or EU consolidated clearance international shipment type is selected, the GCC shipping application 30 will access the port of entry tables 35 and determine the global consolidated port of entry (GCC port of entry) 40 for the packages (see Step 215). The methods used to determine the port of entry for a consolidated shipment are known in the art. The port of entry may be determined based upon geographical considerations or via other criteria specified by the shipper and/or service provider.

In Step 210, the shipper enters the importer of record (sold to) detail for the package into the GCC shipping application 30. If the shipment involves consolidated clearance of packages, the shipper provides invoice line detail for each shipment in the consolidated movement. In a preferred embodiment, the GCC shipping application 30 uses the shipment characteristics entered by the shipper to create summary shipment data 45, which, in a preferred embodiment, includes: a master shipment identifier number 50, clearance country 55, clearance port 60, number of shipments consolidated 65, total weight consolidated 70, total value consolidated 75 and weight unit of measure 80. The processes used to generate and/or capture summary shipment data are known to those skilled in the art.

The following paragraph identifies and describes the function of some of the fields that are found in the summary shipment data 45. In a preferred embodiment, the master shipment identifier 50 is an eleven digit alphanumeric that identifies the shipment and is identical to the shipment identification on the lead GCC doc box 15 for a consolidated shipment. During the consolidated shipment process, the master shipment identifier 50 identifies the child shipments associated with the consolidated shipment. The clearance country 55 indicates the country through which the consolidated clearance shipment will be cleared by customs. The clearance port 60 indicates the custom GCC port of entry 40 for the consolidated movement. The number of shipments consolidated 65 indicates the total number of shipments (including the lead box and all the GCC child shipments 20) associated with the consolidated movement. Total value consolidated 75 is the value of the consolidated clearance shipment. In a preferred embodiment, this value is referenced using the currency that is displayed on the master invoice. Finally, weight unit of measure 80 represents the unit of measure for the total actual weights of the consolidated movement as found in the master invoice. Individual shipment weights may use different units of measure, but the weight of the entire consolidated movement is preferably in one unit of measure, such as pounds or kilograms.

The GCC shipping application 30 creates and stores a master shipment identifier 50 and a package tracking number 90 for each consolidated movement. In a preferred embodiment, the master shipment identifier 50 is used as a doc box shipment number 95 and is assigned by the GCC shipping application 30 during a closeout or end-of-day process. In a preferred embodiment, the master shipment identifier 50 links together each shipment of a master shipment. The master shipment consists of the lead/doc box shipment and the individual child shipments. By delaying the assignment of the master shipment identifier 50 to a closeout period, the shipper is no longer required to know in advance how many shipments are going to be consolidated for clearance. This eliminates the need to change or recreate the over-labels if additional shipments are added to the consolidated movement in the middle of the shipping process.

The GCC shipping application 30 next generates a global consolidated clearance label (GCC label) 100 and an over-label 105 for each GCC child shipment 20 in the consolidated clearance movement. In a preferred embodiment, the address label and over-label are printed on a single 4′×11′ thermal stock. Using processes that are known in the art, the GCC shipping application 30 will also, at the option of the shipper and/or service provider, produce other international documentation, including without limitation NAFTA CO, shippers export declaration (SED), and Certificate of Origin (CO). In a preferred embodiment, the NAFTA CO and certificate of origin are at the master shipment level of detail and the SED is at the child shipment level of detail. In still another embodiment, the GCC shipping application 30 also permits the printing of individual invoices for each of the separate child shipments.

In Step 215, the GCC shipping application 30 determines the GCC port of entry 40 for consolidated movements based on the port of entry tables 35 using processes that are known in the art. In a preferred embodiment, the determination of port of entry is based on data or criteria specified at the time of installation, and this information may be supplemented or changed at designated update intervals. As is known in the art, any of shipment type, ship date, import date, service level, destination country and importer of record can be used to determine the GCC port of entry 40 for a consolidated movement. Once a port of entry 40 is assigned, it is printed in a consolidated invoice detail report, the over-labels 105 for the doc box, and the over-labels 105 for each GCC child shipment 20.

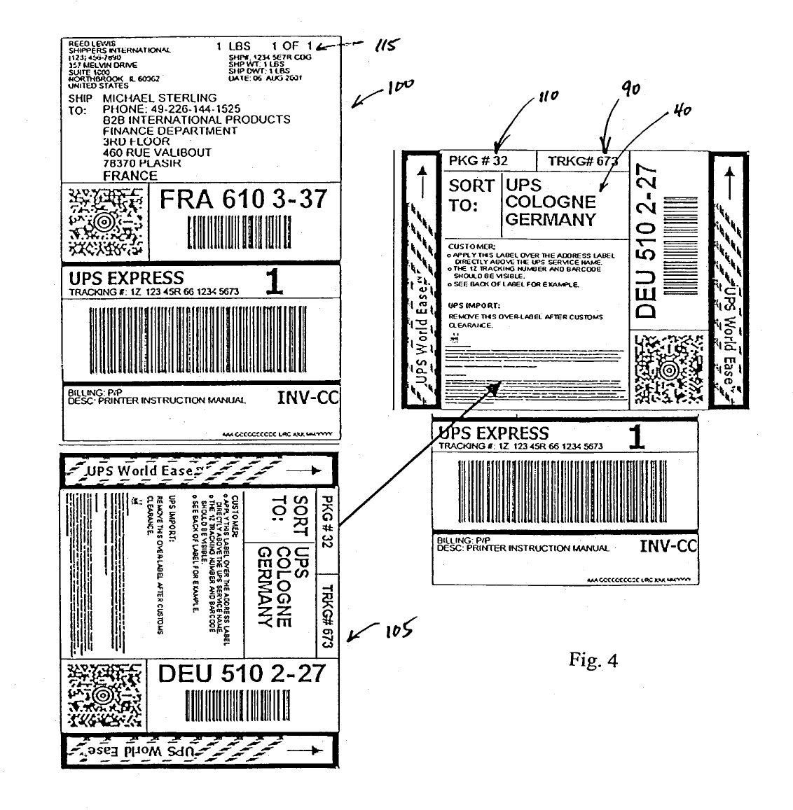

In Step 220, the GCC shipping application 30 generates a consignee address label 100 and an over-label 105 for each package in the master shipment. FIG. 4 illustrates a typical consignee address label 100 and over-label 105 combination using a single piece of stock. In a preferred embodiment, the over-label 105 is detachable and is affixed over the consignee portion of the address label 100. The over-label 105 shows the GCC port of entry 40. Upon clearing customs at the GCC port of entry 40, the over-labels 105 are removed from the shipment, which exposes the final destination address of the consignee. This consignee address is then used to deliver the packages to their ultimate destination. As shown in the figure, fields that are present on the over-label 105 include the last three digits of the package tracking number 90 from the GCC doc box (lead shipment) 15, a package number 110 (PCK #32) that is assigned during processing, the GCC port of entry 40 in alphanumeric form, the GCC port of entry 40 encoded as a two-dimensional, scannable MaxiCode symbol, a postal barcode and a humanreadable routing code. In a preferred embodiment, instructions on how to apply the over-label 105 to the consignee address label 100, and an international Warsaw agreement statement are also printed on the over-label 105.

In a preferred embodiment, the address label includes a package count field 115 at its top right corner. For shipments of predetermined size, the package count field 115 indicates “1 of x,” where x is the number of packages in the child shipment. For shipments of undetermined size, the GCC label 100 indicates “1 of 1” as the package count. Immediately below the package count field 115 are fields for child shipment number, child shipment weight, and ship date. In addition, a shipper return address is disposed in the top left corner of the address label 100 and the consignee destination shipping address immediately below that. Additional shipping information is also shown in the embodiment of FIG. 4 and includes a package tracking number, bar code and a MaxiCode, all of which are well known to those of ordinary skill in the art.

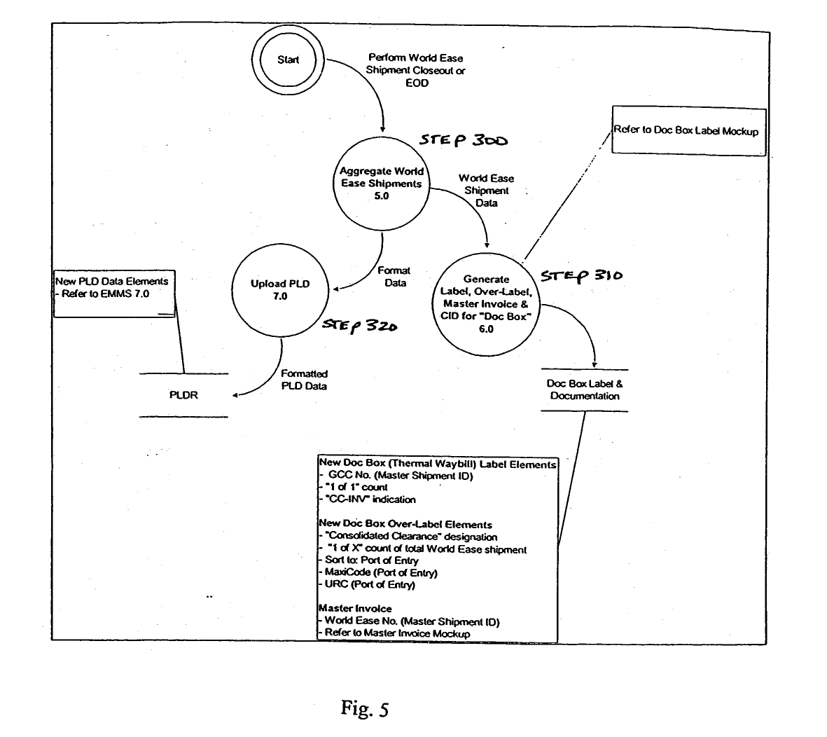

FIG. 5 illustrates the closeout or end-of-day process of the GCC application 30 as it processes GCC doc box 15 shipments in accordance with a preferred embodiment of the present invention. In Step 300, the GCC application 30 aggregates the associated consolidated clearance child shipments by GCC port of entry 40. In one embodiment, the aggregation routine occurs as an end-of-day process. Alternatively, the aggregation can occur as part of a closeout process initiated by the shipper. In either of these embodiments, an end-of-day process refers to an electronic closing of a specific shipment and does not necessarily reflect an end of a business day. Accordingly, multiple end-of-day processes may be performed in a given day.

In the shipper-initiated closeout process, a shipper selects one or more open consolidated clearance shipments to perform an aggregation routine for the purpose of generating a doc box label/over-label, master invoice and consolidated invoice detail report. This shipper-initiated closeout process is particularly valuable to high-volume shippers that need to generate master invoices throughout the day due to time constraints.

In a preferred embodiment, at the initiation of the aggregation routine the GCC application 30 consolidates the individual shipments that are flagged as part of the GCCS 10 service into a master shipment based on some or all of the following consolidation guidelines: all shipments within the master shipment have the same ship date/import date; all shipments within the master shipment have the same importer of record; all shipments within the master shipment have the same exporter; container types may be mixed within the master shipment; all shipments within the master shipment have the same service level; and all shipments within the master shipment clear in the same port.

In Step 310, the GCC shipping application 30 generates a GCC doc box label and over-label for each consolidated movement or EU consolidated movement identified by the end-of-day and/or closeout aggregation process. In a preferred embodiment, a master invoice and a consolidated invoice detail report that summarizes the GCC child shipments in a master shipment are generated for every identified consolidated movement. The GCC shipping application 30 permits the shipper to change the destination information (“ship to” field) for the master invoice and doc box label to the name and address of the importer of record, the term “multiple consignees” with an address of a service provider location on the doc box and no address on the master invoice, or the name and address of a third-party.

In a preferred embodiment, the doc box label includes some or all of the following: a master shipment identifier 50, a “1 of 1” package count, and a ship to address field. The ship to address field defaults to the name and address of the importer of record. And the doc box over-label includes some or all of the following: a package count field 115 with a “1 of x” count of total shipments in the master shipment, a sort to port of entry, a MaxiCode encoded port of entry and an URC port of entry.

In Step 320, PLD is uploaded to the service provider as part of an end-of-day and/or closeout aggregation process. In one embodiment, the upload occurs via the Internet, while in an alternative embodiment, the upload occurs via a telephone network. It will be readily apparent to one of ordinary skill in the art that the transmittal of PLD data to the service provider can occur across various types of networks and using multiple methods of electronic data transmission that are well known in the art. The service provider receives the upload and updates its package tracking databases with the shipment detail. In a preferred embodiment, the PLD for the consolidated shipment is also transmitted electronically to customs. Customs can then use this information using processes that are known in the art to electronically audit the packages that are part of the consolidated shipment. This additional step expedites the customs processing and allows the consolidated shipment to clear customs without delay.

A significant improvement of the above-described GCCS 10 over systems and processes that are presently known in the art is the electronic capture and transmission of PLD information from the customer. The electronic capture of customer shipping data eliminates the manual re-entry of shipping data by the service provider, which saves time and reduces error. Another improvement of the present invention is the generation of a thermal label that includes both the consignee address label and the over-label. In known consolidation systems, as many as three different labels are required for each package in a consolidated movement at least some of which are manually completed.

The present invention also improves known package tracking processes as it provides tracking detail for individual packages within a consolidated movement. In the present invention, individual packages are treated as separate shipments and can be individually tracked. In contrast, under current procedures individual packages are not scanned at every point during the transit process and, accordingly, complete package tracking detail is not available.

The present invention also allows a service provider to guarantee delivery of each shipment. By treating each shipment as individual transactions, the GCC application 30 provides time-in-transit information (an estimation of when the shipment will be delivered), which in turn allows the service provider to offer guaranteed delivery for a shipment. Unlike the present invention, the systems and processes known in the art cannot provide time-in-transit information for packages with a consolidated shipment and therefore cannot guarantee a delivery date.

The present invention also provides a more accurate shipping charge calculation for the consolidated shipment. In a preferred embodiment, the total charges for a consolidated movement are calculated based on each shipment within the movement. Whereas in the manual process known in the prior art, charges are determined even before the customer begins shipping and are based on a predetermined surcharge per consignee regardless of location or distance.

Still another advantage of the present invention is its support of European Union consolidated clearance. Unlike shipping systems known in the art, a user of the present invention may consolidate shipments bound for multiple consignees located in different destinations within the EU. In contrast, existing systems require that all consignees reside in the same country.

Still another benefit of the present invention is the automated selection of the port of entry. The new process allows the customer to preprogram the port of entry city, country and postal code information for each consolidated clear movement into a table that is stored on the application. The shipping system retrieves this information and automatically designates the port of entry without any user intervention during shipment processing. After the completion of a child consolidated shipment, the application will print the port of entry information on each package overlabel in the shipment. In the manual processes of the prior art, customers manually select a port of entry and manually enter the port of entry information on the over-label.

In addition, the new process of the present invention generates a master invoice as part of a closeout or end-of-day process. The invoice detail is electronically captured and provides the information needed to generate the master invoice. This improves on the former, manual process wherein customers manually construct a master invoice for every consolidated shipment.

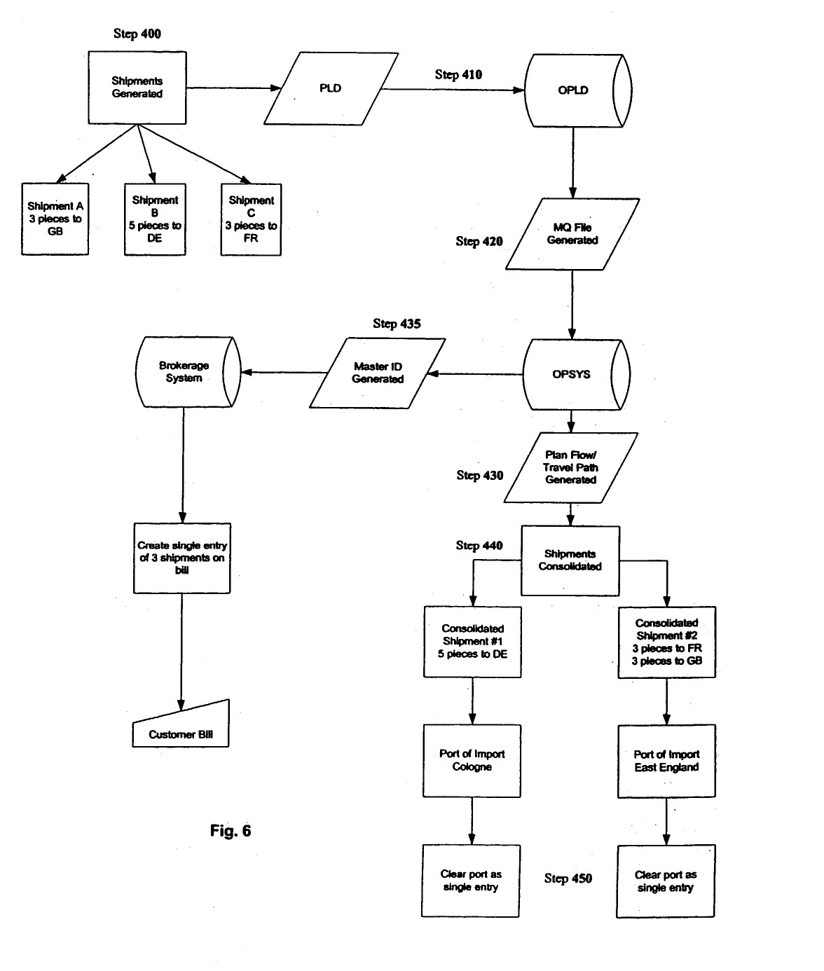

FIG. 6 provides an illustrative process flow for yet another embodiment of a GCCS 10. In Step 400, a shipper creates three shipments: shipment A has three packages bound for Great Britain, shipment B has five pieces bound for Germany and shipment C has three pieces bound for France. The shipper processes the shipments like any other international shipment and as part of the shipment creation process consignee address labels are created and affixed to each package in the shipments. No over-label is required for this embodiment. And each consignee address label includes a unique package tracking number 90. As with any other international shipment, the shipping application generates an invoice and other documentation required for international shipping and the documentation is attached to the shipments.

In Step 410, as part of an end-of-day or closeout process the package level detail for each shipment is uploaded separately to a service provider. In this example, the package shipping application used to generate the three shipments and capture the PLD resides client-side, while the aggregation of like shipments occurs in one or more backend applications that reside on a service provider server. One of ordinary skill in the art, however, will readily recognize that these applications can reside with the client, the service provider or on other servers. The PLD for the shipments will therefore be available upon the arrival of the shipments to a service provider's ODC or export site. In a preferred embodiment, the data received at the ODC or export site is at shipment level.

In Step 420, the PLD is input to the GCC application 30 as individual shipments. To this point no aggregation of like shipments (GCC shipments) has occurred. In FIG. 6, the GCC application is shown as part of a service provider operations system, but again the GCC application 30 may reside elsewhere or, alternatively, that the various functions attributed to the GCC application 30 herein may be split into separate applications that may or may not reside on a single server.

In Step 430, the GCC application 30 generates a travel path that the shipment will follow during its lifecycle within the UPS system 120. The process of generating a travel path is well known in the art. The travel path 120 determines the physical path the shipment will take and the number of days to move the shipment from its current location to its final destination and delivery point. In a preferred embodiment, components of the travel path 120 includes time-in-transit and port of entry 40. Time-in-transit is an estimate of the length of time it will take for a shipment to move from the point of origin, to the port of entry and finally to the destination assuming the shipment is sent using a specific service level, such as ground service. This information is transmitted from the GCC application 30 to an import customs system for pre-clearance of the shipments. The process of plan-flowing GCC shipments the same as regular international shipments provides savings to a service provider by utilizing the existing movements.

In Step 435, the GCC application 30 associates a master ID number for each GCC shipment generated. The creation of GCC shipments is determined via the criteria set forth below (step 440). The master ID number and GCC shipment detail is also preferably transmitted to the service provider's billing system and to a local import brokerage system. Like shipments will clear as one GCC shipment.

In Step 440, the GCC application 30 consolidates like shipments into one GCC shipment. In a preferred embodiment, the consolidation is based upon based on some or all of the following consolidation guidelines: all shipments within a master shipment must have the same ship date/import date; all shipments within a master shipment must have the same importer of record; all shipments within a master shipment must have the same exporter; container types may be mixed within a master shipment; all shipments within a master shipment must have the same service level; and all shipments within a master shipment must clear in the same GCC port of entry 40. Thus, in contrast to the above-described embodiments of the GCCS 10, the determination of which shipments are consolidated is determined by the backend system rather than by the shipper. The customer in this embodiment of the GCCS 10 requires no over-labeling or document box.

In Step 450, the shipments processed by the customer clear customs as a consolidated shipment. In a preferred embodiment, all additional paperwork is produced by the GCCS 10 and presented to customs for clearance. Because the aggregation is performed by the GCCS 10, no special markings or over-label are required on the packages.

The above-described alternative embodiment provides additional benefits over international shipping systems and processes known in the art. For example, in this embodiment the customer is not required to create a doc box for each GCC shipment. Rather, shipments are aggregated by the backend systems operated by the service provider. Another advantage is the elimination of the over-label for each package. Because the shipments travel the same path as ordinary shipments, no special handling is required by operations and only the consignee address label is used during package transit.

Still another benefit to the alternative embodiment is the reduction in special handling of consolidated shipments by the service provider. In the prior embodiment, for example, GCC shipments require an employee of the service provider to segregate and move the GCC shipment as a single unit. In this embodiment, however, GCC shipments are treated as standard shipments and do not require additional or special handling. Thus, the movement of GCC shipments does not require re-direction through different ports and, as a result, all international shipments, including GCC shipments, travel the same path.

The global consolidated clearance system 10, which comprises an ordered listing of selectable services can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it will be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed:

1. A shipping system for shipping international packages, comprising:
a port of entry database; and
a consolidated clearance application, said consolidated clearance application configured to perform the steps of:
capturing shipment characteristics of a plurality of packages, wherein said shipment characteristics comprise an international destination and a consignee associated with each of said plurality of packages;
querying said port of entry database with at least one of said consignee and said international destination to assign a consolidated port of entry to each of said plurality of packages;
assigning each of said plurality of packages to a global consolidated shipment in accordance with a set of consolidation guidelines; and
generating global consolidated shipping labels for each of said plurality of packages.

2. The shipping system of claim 1, wherein said consolidated clearance application is configured to generate a consignee address label and an over-label.

3. The shipping system of claim 2, wherein said consignee address label and said over-label are printed on a single thermal stock.

4. A computer readable substrate having a computer program saved thereupon, said computer program configured to perform the steps of:
capturing a first set of shipment characteristics that are associated with a first package that is bound for a first destination;
capturing a second set of shipment characteristics that are associated with a second package bound for a second destination;
aggregating said first and said second packages as a consolidated international shipment if said first and second sets of shipment characteristics satisfy a requirement for consolidated shipping;
associating a consolidated port of entry to said consolidated international shipment; and
generating a consignee address label and an over-label for said first and second packages.

5. The computer program of claim 4, wherein said first set of shipment characteristics includes a first destination address and a first ship type.

6. The computer program of claim 5, wherein said second set of shipment characteristics includes a second destination address and a second ship type.

7. The computer program of claim 6, wherein said first and said second packages are aggregated as a consolidated international shipment if said first and second ship types identify said first and second packages as international shipments.

8. The computer program of claim 6, wherein said first and said second packages are aggregated as a consolidated international shipment if said first and second ship types identify said first and second packages as international shipments and said first and second packages have a common importer of record.

9. The computer program of claim 4, wherein said first and said second packages are aggregated as a consolidated international shipment if said first and second packages have international destinations, share a common importer of record and a common exporter.

10. The computer program of claim 4, wherein said first and said second packages are aggregated as a consolidated international shipment if said first and second packages have international destinations and share at least one of a common importer of record, exporter and service level.

11. The computer program of claim 4, wherein associating a consolidated port of entry to said consolidated international shipment comprises querying a port of entry table with at least one of a shipment type, shipment date, import date, service level, destination country and importer of record.

12. The computer program of clam 4, further configured to perform the step of associating at least one of summary shipment data, a master shipment identifier and a package tracking number with said consolidated international shipment.

13. The computer program of claim 4, wherein the step of generating a consignee address label and an over-label for said first and second packages comprises generating said address label and said over-label on a single piece of stock.

14. The computer program of claim 4, wherein said aggregation of said first and second packages into said consolidated shipment occurs as part of an end-of-day process.

15. The computer program of claim 4, wherein said aggregation of said first and second packages into said consolidated shipment occurs as part of a closeout process.

16. The computer program of claim 4, wherein a third package is consolidated with said first and second packages.

17. The computer program of claim 16, wherein said over-label includes a count of packages included in said consolidated shipment.

18. The computer program of claim 4, wherein said first and second packages are bound for different consignees located in different countries within the European Union.

19. The computer program of claim 4, configured to perform the additional step of uploading said first and second sets of shipment characteristics to a service provider.

20. The computer program of claim 4, further configured to perform the step of assigning a package tracking number to each package within said consolidated shipment.

21. The computer program of claim 4, further configured to track said first and second packages and provide time-in-transit information
